(19) United States
(12) Patent Application Publication
(10) Pub. No.: US 2013/0282853 A1
(43) Pub. Date: Oct. 24, 2013

(54) APPARATUS AND METHOD FOR PROCESSING DATA IN MIDDLEWARE FOR DATA DISTRIBUTION SERVICE

(71) Applicant: ELECTRONICS AND TELECOMMUNICATIONS RESEARCH IN, Daejeon-city (KR)

(72) Inventors: Hyung-Kook Jun, Seoul (KR); Soo-Hyung Lee, Daejeon (KR); Jae-Hyuk Kim, Gunpo (KR); Kyeong-Tae Kim, Daejeon (KR); Won-Tae Kim, Asan (KR)

(73) Assignee: ELECTRONICS AND TELECOMMUNICATIONS RESEARCH INSTITUTE, Daejeon-city (KR)

(21) Appl. No.: 13/655,950

(22) Filed: Oct. 19, 2012

(30) Foreign Application Priority Data
Apr. 20, 2012 (KR) 10-2012-0041577

(51) Int. Cl. G06F 15/167

(52) U.S. Cl. 709/213

(57) ABSTRACT

The present invention relates to an apparatus and method that are capable of optimizing the overall performance of DDS middleware for processing data by managing network threads, writer/reader threads, and memory resources. For this, an apparatus for processing data in middleware for DDS includes a network thread management module for managing, using a thread pool, a network thread which has sockets for transmitting or receiving data to or from a network in an RTPS layer. A lock-free queue management module manages a lock-free queue which has a lock-free function and which transmits or receives the data to or from the network thread. A writer/reader thread management module manages a writer thread and a reader thread so that the writer thread or the reader thread transmits or receives the data to or from the lock-free queue and performs a behavior in the RTPS layer.

### CROSS REFERENCE TO RELATED APPLICATION

This application claims the benefit of Korean Patent Application No. 10-2012-0041577, filed on Apr. 20, 2012, which is hereby incorporated by reference in its entirety into this application.

### BACKGROUND OF THE INVENTION

### Technical Field

The present invention relates generally to an apparatus and method for processing data in middleware for Data Distribution Service (DDS) and, more particularly, to an apparatus and method that are capable of optimizing the overall performance of DDS middleware for processing data by managing network threads, writer/reader threads, and memory resources that are used to execute applications in the DDS middleware.

Data communication middleware functions to execute a data exchange function, which was provided by applications, for the applications. Further, data communication middleware functions to dynamically construct a network in a ubiquitous environment in which various devices are present, and then form a communication network domain. As current data communication middleware for data exchange, various types of data communication middleware, such as a Web Service, a Common Object Request Broker Architecture (CORBA), and Java Message Service (JMS), have been developed. Such data communication middlewares have been used in various application domains which have individual characteristics, but most data communication middleware uses a centralized method and then has a data management structure based on a central server. In a structure such as in a current ubiquitous environment in which a plurality of devices dynamically construct a network and frequently provide data in distributed form, a centralized data management structure is not efficient. Therefore, in order to construct a data domain and efficiently transmit data in such a distributed environment, the Object Management Group (OMG), which is the International software standardization organization, proposed middleware standards for Data Distribution Service (DDS). The DDS proposed by the OMG provides a network communication environment in which a network data domain is dynamically formed and individual embedded or mobile devices can freely participate in or withdraw from the network data domain. For this function, DDS provides a publish/subscribe environment to users, thereby providing the function of allowing the users to create, collect and consume their desired data without requiring additional jobs to be performed on the desired data.

A publish/subscribe model for DDS virtually eliminates the complicated network programming of distributed applications and supports mechanisms beyond a basic publish/subscribe model. The principal advantages obtained by applications using DDS for communication are that a very short design time is required so as to handle mutual responses, and in particular, applications do not require information about other participating applications including locations or presence. DDS automatically handles all items related to the sending of messages, including ‘who will receive a message’, ‘where a subscriber is located’, ‘what happens when a message cannot be sent’, etc., without receiving any interruption request from user applications.

Further, DDS permits a user to set Quality of Service (QoS) parameters and describes methods used when sending or receiving messages that include an auto-discovery mechanism. DDS completely anonymously exchanges messages, thereby providing a basis for simplifying the design of distributed applications and implementing desirably structured modular programs.

The basic structure of DDS proposed by the OMG can be divided into a Data Centric Publish/Subscribe (DCPS) layer and a Real-Time Publish/Subscribe (RTPS) layer. Of these layers, the DCPS layer is a data publish/subscribe function interface provided to applications, so that each application performs only the publishing/subscribing of desired data without recognizing the other party with whom data is to be exchanged. Meanwhile, the RTPS layer is a data transmission protocol for the data-centric distribution service standardized by the OMG, supports a data publish/subscribe communication model, and is designed to be operable even on an unreliable transport layer as in the case of a User Datagram Protocol Internet Protocol (UDP/IP). Basic modules constituting such an RTPS layer include a structure module for defining entities participating in communication upon exchanging data, a message module for defining messages to be used to exchange information between writers and readers, a behavior module for defining message sending procedures that must be performed depending on status and temporal conditions between writers and readers, and a discovery module for performing the function of discovering information about data distribution-related entities present in a domain. In this case, the discovery module uses a Participant Discovery Protocol (PDP) that is a protocol defined to discover participants on different networks, and an Endpoint Discovery Protocol (EDP) that is a protocol used to exchange discovered information between different end points such as writers or readers.

DDS middleware is data-centric communication middleware, unlike other types of communication middleware, and is configured such that a large number of data communication entities transmit small-sized data in real time, and thus an efficient implementation of the data transmission/reception of communication entities is required. Further, due to the presence of two layers, that is, the DCPS layer and the RTPS layer, when the implementation of the two layers is not efficient and the mutual transfer of data between the two layers is not performed, the overall performance of the DDS middleware system is influenced. Therefore, technology for optimizing the performance of the overall DDS middleware without violating the data-centric characteristics of DDS middleware is currently being required.

### SUMMARY OF THE INVENTION

Accordingly, the present invention has been made keeping in mind the above problems occurring in the prior art, and an object of the present invention is to provide technology for guaranteeing the parallelism of DDS middleware and optimizing memory and threads by managing network threads, writer/reader threads, and memory resources that are used to execute applications in the DDS middleware.

Another object of the present invention is to provide technology for more efficiently transmitting or receiving data when implementing DDS middleware.

In accordance with an aspect of the present invention to accomplish the above objects, there is provided an apparatus for processing data in middleware for Data Distribution Service (DDS), including a network thread management module for managing, using a thread pool, a network thread which has sockets for transmitting or receiving data to or from a network in a Real-Time Publish/Subscribe (RTPS) layer that is a data transport layer of middleware for the DDS; a lock-free queue management module for managing a lock-free queue which has a lock-free function and which transmits or receives the data to or from the network thread; and a writer/reader thread management module for managing a writer thread and a reader thread so that the writer thread or the reader thread transmits or receives the data to or from the lock-free queue and performs a behavior in the RTPS layer.

Preferably, the apparatus may further include a memory management module that is allocated memory resources requested by the middleware from a system that uses the DDS and that provides the memory resources.

Preferably, the memory management module may include a memory management unit configured to be previously allocated predetermined memory resources from the system that uses the DDS and to manage the allocated memory resources; a cache configured to, if the middleware requests memory resources of a specific data type, be allocated memory resources from the memory management unit, convert the allocated memory resources into a specific data type requested by the middleware, and provide the converted memory resources; and a structure management unit configured to structure and manage data types requested by the middleware.

Preferably, the structure management unit may manage the data types requested by the middleware using one or more of tree, heap and buffer management structures.

Preferably, the sockets may be one or more of a Participant Discovery Protocol (PDP) socket, an Endpoint Discovery Protocol (EDP) socket, and a data socket.

Preferably, the network thread may include a socket manager for managing the sockets, and the socket manager is shared among network threads of the thread pool.

Preferably, the socket manager may use a structure based on one or more of select, poll, epoll, and kqueue system call schemes.

Preferably, the network thread may generate a job to be allocated to the writer thread or the reader thread if new data arrives from the network.

Preferably, the writer/reader thread management module may include a job queue for allocating the job generated by the network thread to the writer thread or the reader thread.

Preferably, the job may include fields including an entity pointer, packet data, behavior status, and a job time schedule.

Preferably, the lock-free queue may be implemented using Compare And Swap (CAS) instructions.

In accordance with another aspect of the present invention to accomplish the above objects, there is provided a method of processing data in middleware for Data Distribution Service (DDS), including constructing a network thread which supports a thread pool and which has sockets for transmitting or receiving data to or from a network in a Real-Time Publish/Subscribe (RTPS) layer that is a data transport layer of middleware for the DDS; the network thread transmitting data received from the network to a lock-free queue having a lock-free function; and a writer thread or a reader thread reading the data from the lock-free queue and then performing a behavior in the RTPS layer.

Preferably, the constructing the network thread may include integrating all network threads into a single network thread; generating sockets based on the single network thread; generating a socket manager for managing the sockets; multiplexing the single network thread into a plurality of network threads, thus generating a thread pool; connecting the socket manager to the sockets; and connecting the socket manager to the thread pool so that the thread pool shares the socket manager.

Preferably, the sockets may be one or more of a Participant Discovery Protocol (PDP) socket, an Endpoint Discovery Protocol (EDP) socket, and a data socket.

Preferably, the writer thread or the reader thread performing the behavior in the RTPS layer may include a job queue aligning jobs generated by the network thread based on times; and the writer thread or the reader thread reading a job located at an uppermost position of the job queue and then performing the behavior in the RTPS layer.

Preferably, the writer thread or the reader thread performing the behavior in the RTPS layer may include if an additional periodic behavior to be performed by the writer thread or the reader thread is required, generating a new job for the additional periodic behavior; and indicating a time at which the additional periodic behavior is to be performed, and inserting the generated new job into the job queue.

Preferably, the job may include fields including an entity pointer, packet data, behavior status, and a job time schedule.

Preferably, the lock-free queue may be implemented using Compare And Swap (CAS) instructions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of an apparatus for processing data in middleware for Data Distribution Service (DDS) according to the present invention;

FIG. 2 is a diagram schematically showing the structure of DDS middleware managed by the apparatus for processing data in middleware for DDS according to the present invention;

FIG. 3 is a diagram showing the configuration and operation of a network thread managed by the network thread management module of FIG. 1;

FIG. 4 is a diagram showing a scheme for implementing a lock-free queue managed by the lock-free queue management module of FIG. 1;

FIG. 5 is a diagram showing the execution structure of a writer thread and a writer job queue managed by the writer/reader thread management module of FIG. 1;

FIG. 6 is a diagram showing the execution structure of a reader thread and a reader job queue managed by the writer/reader thread management module of FIG. 1;

FIG. 7 is a block diagram showing the configuration of the memory management module of FIG. 1; and

FIGS. 8 to 10 are flowcharts showing a method of processing data in middleware for DDS according to the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, the configuration and operation of an apparatus for processing data in middleware for Data Distribution Service (DDS) according to the present invention will be described.

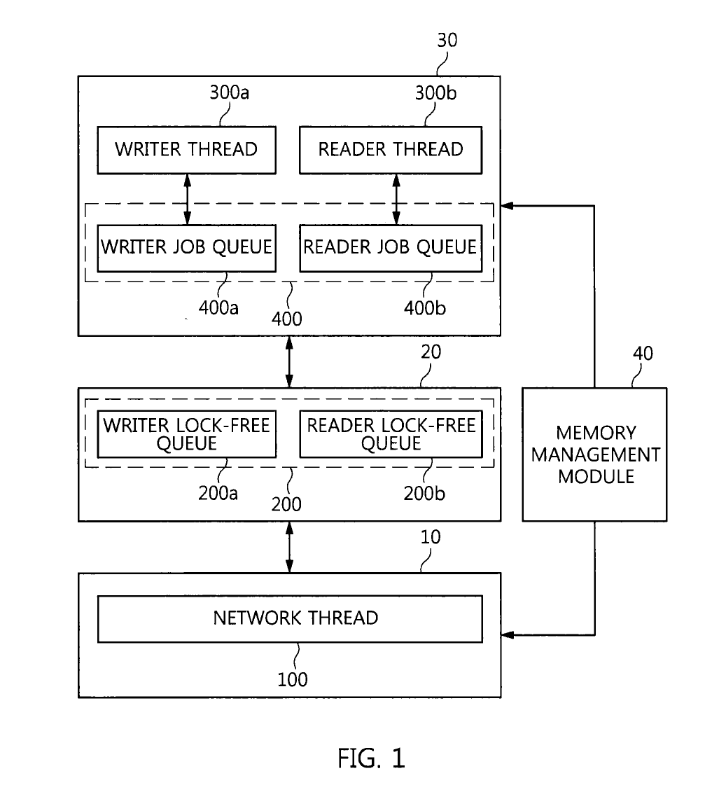

FIG. 1 is a block diagram showing the configuration of an apparatus for processing data in middleware for DDS according to the present invention.

Referring to FIG. 1, the apparatus for processing data in middleware for DDS according to the present invention includes a network thread management module 10, a lock-free queue management module 20, a writer/reader thread management module 30, and a memory management module 40. The network thread management module 10 manages a network thread 100 that supports a thread pool in DDS middleware. The lock-free queue management module 20 manages a lock-free queue 200 including a writer lock-free queue 200a and a reader lock-free queue 200b which receive data from the network thread 100 and provide a lock-free function. The writer/reader thread management module 30 manages a writer thread 300a and a reader thread 300b which receive pieces of data from the writer lock-free queue 200a and the reader lock-free queue 200b, respectively, and provide the RTPS behavior function of the DDS middleware, and also manages a job queue 400 which includes a writer job queue 400a and a reader job queue 400b for allocating jobs to the writer thread 300a and the reader thread 300b, respectively. The memory management module 40 improves the reusability of previously allocated memory and the memory management efficiency of the system.

The network thread management module 10 manages network threads having sockets for transmitting or receiving data to or from a network in an RTPS layer which is the data transport layer of DDS middleware, using the concept of a thread pool.

The lock-free queue management module 20 manages the lock-free queue 200 that is a First-In First-Out (FIFO) queue having a lock-free function so that the lock-free queue 200 transmits or receives data to or from the network thread 100 managed by the network thread management module 10 using the concept of the thread pool.

The writer/reader thread management module 30 manages the writer thread 300a and the reader thread 300b so that the writer thread 300a or the reader thread 300b transmits or receives data to or from the lock-free queue and performs a specific behavior in the RTPS layer. Further, the writer/reader thread management module 30 manages the writer job queue 400a and the reader job queue 400b so that the writer job queue 400a allocates a job allowing a specific behavior in the RTPS layer to be performed to the writer thread 300a or so that the reader job queue 400b allocates a job allowing a specific behavior in the RTPS layer to be performed to the reader thread 300b.

The memory management module 40 is previously allocated predetermined memory resources from a system that uses DDS, converts the previously allocated memory resources into a requested data type if the DDS middleware requests memory resources of a specific type, and provides resulting data to the DDS middleware.

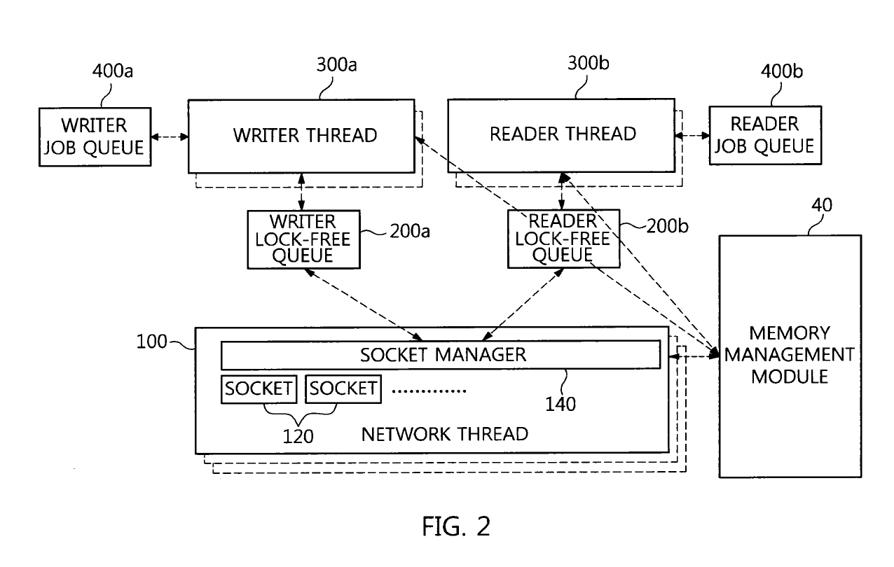

FIG. 2 is a diagram schematically showing the structure of DDS middleware managed by the apparatus for processing data in middleware for DDS according to the present invention.

Referring to FIG. 2, by the apparatus for processing data in middleware for DDS shown in FIG. 1, a DDS middleware system according to the present invention has a structure including a network thread 100, a writer lock-free queue 200a and a reader lock-free queue 200b, a writer thread 300a and a reader thread 300b, and a writer job queue 400a and a reader job queue 400b.

In more detail, the DDS middleware system managed by the apparatus for processing data in middleware for DDS according to the present invention includes the network thread 100 which includes multiple sockets 120 and a socket manager 140 for managing the multiple sockets 120 and which supports a thread pool. Further, the DDS middleware system includes the writer and reader lock-free queues 200a and 200b which receive data from the network thread 100, transfer the received data to the writer thread 300a or the reader thread 300b, and provide a lock-free function. Furthermore, the DDS middleware system includes the writer and reader threads 300a and 300b which receive data from the writer lock-free queue 200a or the reader lock-free queue 200b and are capable of performing a behavior in the RTPS layer of the DDS middleware and providing a thread pool function. Furthermore, the DDS middleware system includes the writer and reader job queues 400a and 400b which allocate to the writer thread 300a or the reader thread 300b the jobs which allow a behavior in the RTPS layer of the DDS middleware to be performed, and the memory management module 40 which is previously allocated all memory resources of the DDS middleware system and provides memory resources required by respective threads.

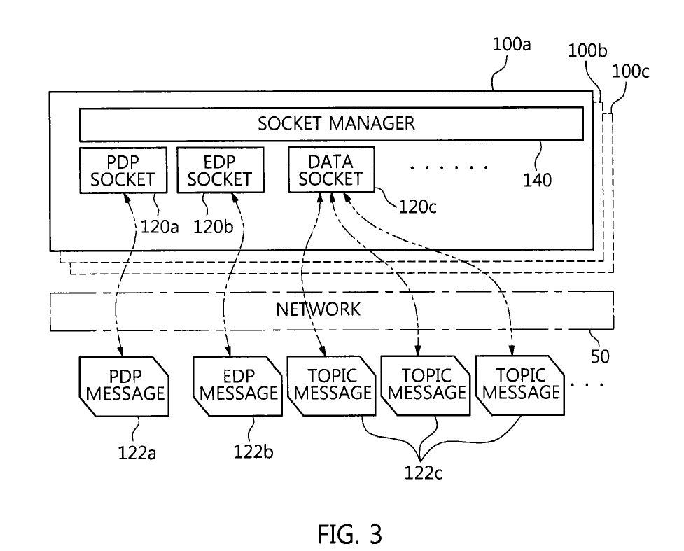

FIG. 3 is a diagram showing the configuration and operation of the network thread 100 managed by the network thread management module 10 of FIG. 1.

Referring to FIG. 3, the network thread 100 managed by the network thread management module 10 includes sockets and a socket manager 140. The sockets are used in the DDS middleware system and include a Participant Discovery Protocol (PDP) socket 120a for transmitting or receiving a PDP message 122a over a network 50, an Endpoint Discovery Protocol (EDP) socket 120b for transmitting or receiving an EDP message 122b, and a data socket 120c for transmitting or receiving a topic message 122c. Further, the socket manager 140 uses a thread pool for efficient transfer of data via the sockets. In this case, the socket manager 140 may communicate with the sockets using a structure based on one or more of select, poll, epoll, and kqueue system call schemes. The thread pool is composed of a plurality of network threads 100a, 100b, and 100c which have the same function and share the socket manager 140 with one another, and is configured to, if an event such as the arrival of data occurs on the sockets, wake up actual sockets and use them to transmit or receive data.

In greater detail, the network thread 100 is implemented as a thread pool generated via the procedure of multiplexing into the plurality of network threads 100a, 100b, and 100c. For this, the plurality of network threads are integrated into a single network thread. Three sockets 120a, 120b, and 120c for each of PDP, EDP, and data, are generated for each of a writer and a reader based on the single integrated network thread. Next, a socket manager which will manage the individual sockets is generated, and the single integrated network thread is multiplexed into the plurality of network threads 100a, 100b, and 100c that have been generated in correspondence with the performance of the DDS middleware system by using the concept of the thread pool. In this case, it is preferable to basically make the number of network threads multiplexed by the thread pool equal to a number that is twice the number of CPUs of the DDS system, but this is not necessarily limited thereto. The thread pool is operated such that when any data is received via an arbitrary socket 120, the DDS middleware system first provides a method of allowing the socket manager 140 to directly process the data reception event and multiplex the network threads in such a way as to multiplex the received data using a multiplexing method such as a select or poll method. Finally, after the socket manager 140 is connected to the sockets 120, the socket manager 140 is connected to the thread pool of the network thread 100.

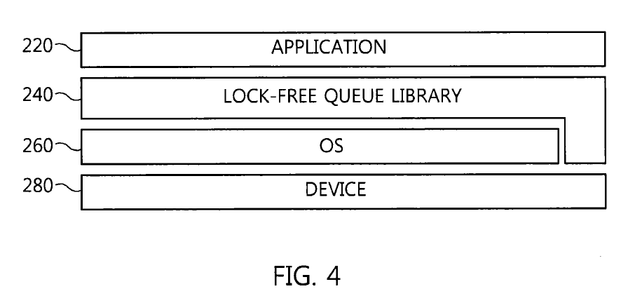

FIG. 4 is a diagram showing a scheme for implementing the lock-free queue 200 managed by the lock-free queue management module 20 of FIG. 1.

Referring to FIG. 4, an application 220 implements a lock-free queue 200 composed of a writer lock-free queue 200a and a reader lock-free queue 200b using a lock-free queue library 240. In this case, the lock-free queue 200 may be implemented using the Compare And Swap (CAS) instruction of a device 280 that is not provided by an Operating System (OS) 260.

Read operations occur more frequently than do write operations when accessing data in most software. In such a data structure in which read operations occur the most often, a synchronization technique such as Read Copy Update (RCU) in which read operations mainly occur and a large part of write operations are mainly used for a very small object, guarantees that a reader has scalable performance. The synchronization technique such as RCU is advantageous in that reader operations are wait-free and the overhead thereof is extremely small, but is problematic in that the overhead of write operations is large, and thus performance is deteriorated on the contrary in a data structure in which write operations occur more frequently than do read operations. Therefore, the present invention can bring about an improvement in the overall performance of DDS middleware by replacing a FIFO queue, which was applied to conventional DDS middleware, with a lock-free FIFO queue.

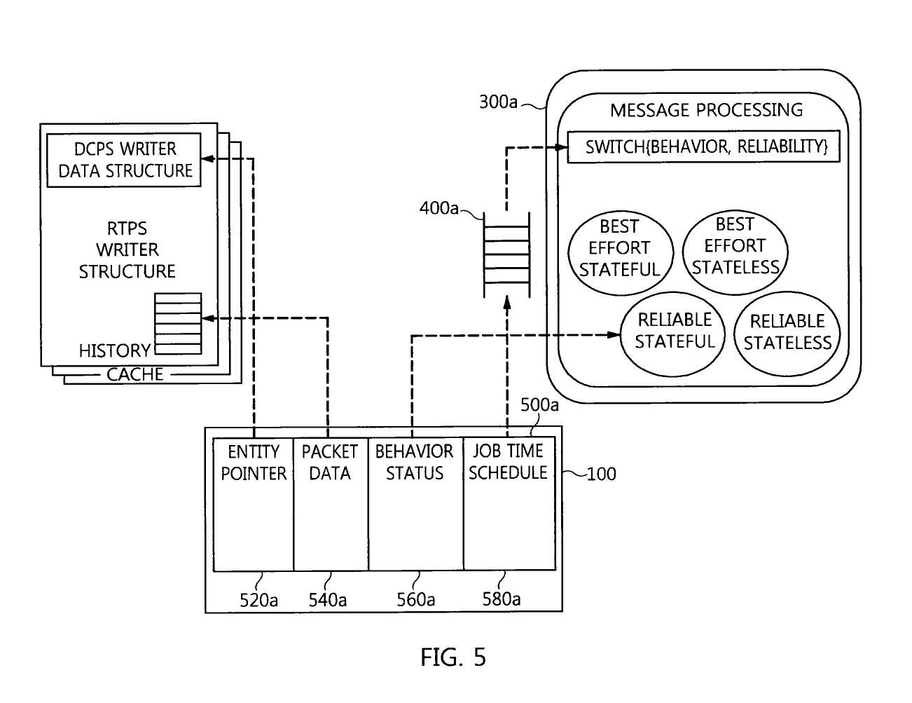

FIG. 5 is a diagram showing the execution structure of the writer thread 300a and the writer job queue 400a managed by the writer/reader thread management module 30 shown in FIG. 1.

Referring to FIG. 5, when an event indicating that new data to be processed by the writer thread 300a has arrived from the network occurs, the network thread 100 generates a single job 500a and inserts it into the writer job queue 400a. The writer thread 300a reads the job 500a from the writer job queue 400a and then performs a behavior in the RTPS layer. In this case, the levels of the behavior performed by the writer thread 300a can be classified into ‘stateless’ and ‘stateful’ levels as QoS levels for high reliability. Criteria for the classification of these levels depend on whether the state of a reader should be recorded. In this case, if the state of the reader should be recorded, the level of a behavior is a ‘stateful’ level, otherwise it is a ‘stateless’ level. The level of the behavior performed by the writer thread 300a is widely known as a ‘best effort stateful’ level or the like by other well-known DDS middleware systems, and thus a detailed description thereof will be omitted in the present specification.

The job 500a inserted into the writer job queue 400a may be composed of a total of four fields, which are an entity pointer 520a pointing at a writer data structure, packet data 540a received from an actual network, behavior status 560a which is the status of behavior to be performed by the writer thread 300a, and a job time schedule 580a that is the time at which the job 500a is generated.

The DDS middleware system is intended to have a structure in which all of a plurality of writer entities required for the DDS middleware system are performed using a single thread for performing a behavior. In this case, the execution efficiency of the system can be improved compared to the case where a plurality of unnecessary threads are generated. Here, the writer job queue 400a is a queue having a time-ordering attribute, in which jobs 500a generated by the network thread 100 are aligned based on times, thus allowing the writer thread 300a to process the jobs 500a in their temporal sequence. That is, the writer threads corresponding to the writer entities are operated as a single writer thread, so that the efficiency of the system is improved. Further, jobs 500a allocated to the writer thread 300a are managed using the time-ordered writer job queue 400a so as to process periodic events or to process repetitive data, thus more efficiently performing the processing of repetitive data. Here, the writer thread 300a can be managed by the writer/reader thread management module 30 as a thread pool according to the performance of the system.

An operation between the writer thread 300a and the writer job queue 400a will be described below. First, when an event such as the arrival of data from the network thread 100 occurs on the writer thread 300a, an RTPS entity structure in which the event occurs, data, behavior status, and time information are inserted into the writer job queue 400a. The writer thread 300a reads a job located at the uppermost position of the writer job queue 400a and then performs a behavior in the RTPS layer. If an additional periodic behavior to be performed by the writer thread 300a is required, an RTPS entity structure, data, behavior status, and time information related to the additional periodic behavior are inserted into the writer job queue 400a. Here, the time at which a subsequently added job is to be performed is indicated on the writer job queue 400a.

The writer job queue 400a basically calculates the time of a job queue from the time at which a new event such as the arrival of data from the network occurs and the time at which an event previously occurred, and performs time ordering. A routine for checking the time of the writer job queue 400a may be implemented using a select function or a cond_wait_timed function. In more detail, a method of checking the time of the writer job queue 400a is described below. First, when a new event such as the arrival of data from the network occurs, the time of a job queue is calculated upon processing the new event. Further, if a job having a time previous to the occurrence time of the corresponding event is present in the writer job queue 400a, that job is first processed. If any other new jobs are not added to the writer job queue 400a, the job based on the occurrence of the new event is performed. If, during the procedure of processing the job based on the occurrence of the new event, an additional periodic behavior to be performed by the writer thread 300a is required, a new job corresponding to the additional periodic behavior is generated and the time thereof is recorded, and then the new job is added to the writer job queue 400a. The writer job queue 400a calculates the times of the jobs inserted into the job queue for respective events, and performs time ordering on the inserted jobs depending on the calculated times, thereby allowing the writer thread 300a to process the jobs in the temporal sequence of the jobs. In this case, the writer thread 300a sleeps for a period corresponding to the minimum time of an initial job on the list of the write job queue 400a using a select function or a cond_wait_timed function within the writer thread 300a, and thereafter processes the events in the write job queue 400a.

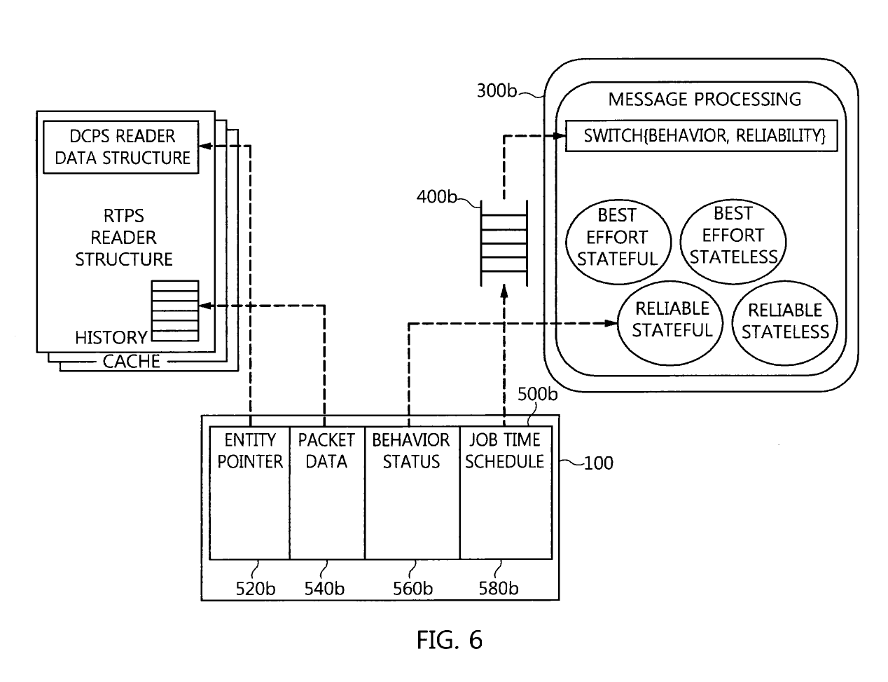

FIG. 6 is a diagram showing the execution structure of the reader thread 300b and the reader job queue 400b managed by the writer/reader thread management module 30 of FIG. 1.

Referring to FIG. 6, when an event such as the arrival of new data to be processed by the reader thread 300b from the network occurs, the network thread 100 generates a single job 500b and then inserts the generated job into the reader job queue 400b. The reader thread 300b reads the job 500b from the reader job queue 400b and then performs a behavior such as a ‘best effort stateful’ behavior or the like in the RTPS layer. In this case, the job 500b inserted into the reader job queue 400b may be composed of a total of four fields. These fields are an entity pointer 520b pointing at a reader data structure, packet data 540b actually received from the network, behavior status 560b which is the status of a behavior to be performed by the reader thread 300b, and a job time schedule 580b that is the time at which the job 500b is generated.

The reader job queue 400b is a queue having a time-ordering attribute, in which jobs 500b generated by the network thread 100 are aligned based on times, thus allowing the reader thread 300b to process the jobs 500b in their temporal sequence. That is, the reader threads corresponding to the reader entities are operated as a single reader thread, so that the efficiency of the system is improved. Further, jobs 500b allocated to the reader thread 300b are managed using the time-ordered reader job queue 400b so as to process periodic events or to process repetitive data, thus more efficiently performing the processing of repetitive data. Here, the reader thread 300b can be managed by the writer/reader thread management module 30 as a thread pool according to the performance of the system.

An operation between the reader thread 300b and the reader job queue 400b will be described below. First, when an event such as the arrival of data from the network thread 100 occurs on the reader thread 300b, an RTPS entity structure in which the event occurs, data, behavior status, and time information are inserted into the reader job queue 400b. The reader thread 300b reads a job located at the uppermost position of the reader job queue 400b and then performs a behavior in the RTPS layer. If an additional periodic behavior to be performed by the reader thread 300b is required, an RTPS entity structure, data, behavior status, and time information related to the additional periodic behavior are inserted into the reader job queue 400b. Here, the time at which a subsequently added job is to be performed is indicated on the reader job queue 400b.

The reader job queue 400b basically calculates the time of a job queue from the time at which a new event such as the arrival of data from the network occurs and the time at which an event previously occurred, and performs time ordering. A routine for checking the time of the reader job queue 400b may be implemented using a select function or a cond_wait_timed function. In more detail, a method of checking the time of the reader job queue 400b is described below. First, when a new event such as the arrival of data from the network occurs, the time of a job queue is calculated upon processing the new event. Further, if a job having a time previous to the occurrence time of the new event is present in the reader job queue 400b, that job is first processed. If any other new jobs are not added to the reader job queue 400b, the job based on the occurrence of the new event is performed. If, during the procedure of processing the job based on the occurrence of the new event, an additional periodic behavior to be performed by the reader thread 300b is required, a new job corresponding to the additional periodic behavior is generated and the time thereof is recorded, and then the new job is added to the reader job queue 400b. The reader job queue 400b calculates the times of the jobs inserted into the job queue for respective events, and performs time ordering on the inserted jobs depending on the calculated times, thereby allowing the reader thread 300b to process the jobs in the temporal sequence of the jobs. In this case, the reader thread 300b sleeps for a period corresponding to the minimum time of an initial job on the list of the reader job queue 400b using a select function or a cond_wait_timed function within the reader thread 300b, and thereafter processes the events in the reader job queue 400b.

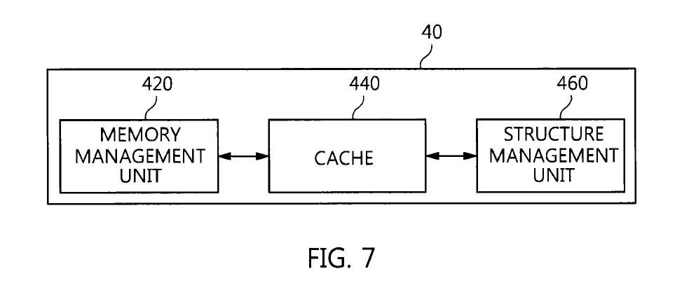

FIG. 7 is a block diagram showing the configuration of the memory management module 40 of FIG. 1.

Referring to FIG. 7, the memory management module 40 is a user-level memory resource management module that is previously allocated the memory to be used by a DDS application from a DDS system and then uses the memory upon executing the DDS application. The memory management module 40 includes a memory management unit 420, a cache 440, and a structure management unit 460. In the apparatus for processing data in middleware for DDS according to the present invention, the memory management module 40 is previously allocated the memory resources requested by DDS middleware using the configuration information of the DDS system, and the user accesses the user-level memory resources using the memory resource access management interface according to the present invention, instead of system functions such as the malloc and free functions.

The memory management unit 420 is previously allocated predetermined memory resources from the memory of the DDS system and then manages the allocated memory resources. The memory management unit 420 manages the memory resources previously allocated from the DDS system as a memory resource pool, and then provides memory resources required to execute the DDS application.

The cache 440 is configured to, if the DDS middleware requests memory resources of a specific data type required to execute the application, be allocated memory resources from the memory management unit 420, convert the memory resources into the specific data type requested by the DDS middleware, and provide resulting data to the DDS middleware. That is, the cache 440 has a structure capable of managing memory resources for respective data types by requesting memory resources from the memory management unit 420 at the request of the DDS middleware, and by converting the memory resources allocated from the memory management unit 420 into a type suitable for the type of DDS application.

The structure management unit 460 structures and manages data types requested by the DDS middleware. For this, the structure management unit 460 has a data management structure for inserting, eliminating, accessing, and managing memory resources for respective data types in conformity with the structure of DDS. In this case, the structure management unit 460 may manage data types using one or more of tree, heap and buffer management structures.

An operation in which the memory management module 40 manages memory resources so as to manage the use of the memory resources in the DDS system is described below. That is, when the DDS middleware requests memory resources of a specific type which are required to execute an application from the cache 440, the cache 440 requests the memory resources requested by the DDS middleware from the memory management unit 420 and is then allocated the corresponding memory resources. The memory resources allocated from the memory management unit 420 to the cache 440 are converted into a specific data type requested by the DDS middleware via the cache 440 and then resulting data is provided to the DDS middleware. The memory resources of the specific data type provided in this way are used by the DDS system to execute the application. During this procedure, in order for the DDS system to efficiently search for the specific data type provided by the cache 440, the structure management unit 460 structures and manages data types.

Hereinafter, a method of processing data in middleware for DDS according to the present invention will be described in detail. A description of some repetitive operations identical to those of the apparatus for processing data in middleware for DDS according to the present invention which has been described with reference to FIGS. 1 to 7 will be omitted.

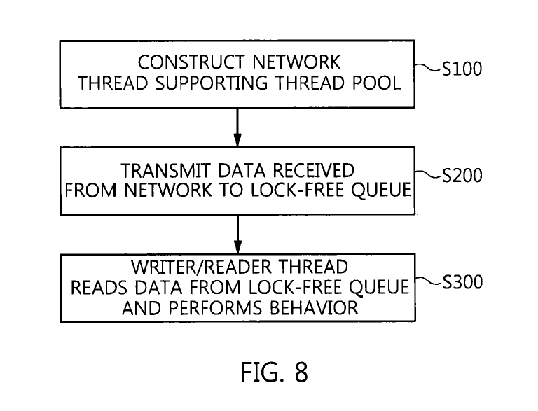

FIG. 8 is a flowchart showing a method of processing data in middleware for DDS according to the present invention.

Referring to FIG. 8, in the method of processing data in middleware for DDS according to the present invention, a network thread having sockets for transmitting or receiving data to or from a network and supporting a thread pool is constructed in an RTPS layer that is the data transport layer of DDS middleware at step S100.

Next, the network thread transmits the data received from the network to a lock-free queue having a lock-free function at step S200. In this case, if the data received from the network is data to be processed by a writer thread, the network thread transmits the data to a writer lock-free queue, whereas if the received data is data to be processed by a reader thread, the network thread transmits the data to a reader lock-free queue.

Further, the writer thread or the reader thread reads the data from the writer lock-free queue or the reader lock-free queue, and then performs a behavior in the RTPS layer at step S300.

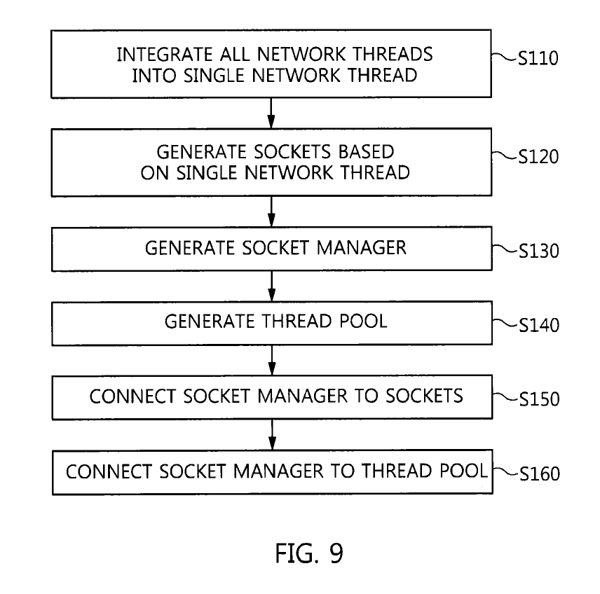

FIG. 9 is a flowchart showing in detail the step S100 of constructing the network thread in the flowchart shown in FIG. 8.

Referring to FIG. 9, at step S100, all network threads are integrated into a single network thread at step S110.

Next, sockets are generated based on the single network thread integrated at step S110 at step S120, and a socket manager for managing the generated sockets is generated at step S130. At step S120, one or more of a PDP socket for transmitting or receiving a PDP message over the network, an EDP socket for transmitting or receiving an EDP message, and a data socket for transmitting or receiving a topic message are generated as the sockets used in the DDS middleware system. Further, at step S120, three sockets for each of PDP, EDP, and data can be generated for each of a writer and a reader based on the single network thread integrated at step S110.

Further, the single integrated network thread is multiplexed into a plurality of network threads and then a thread pool is generated at step S140. The socket manager generated at step S130 is connected to the sockets generated at step S120 at step S150. The number of network threads multiplexed to generate the thread pool at step S140 may be twice the number of CPUs of the DDS system.

Finally, the socket manager is connected to the thread pool so that the thread pool shares the socket manager at step S160.

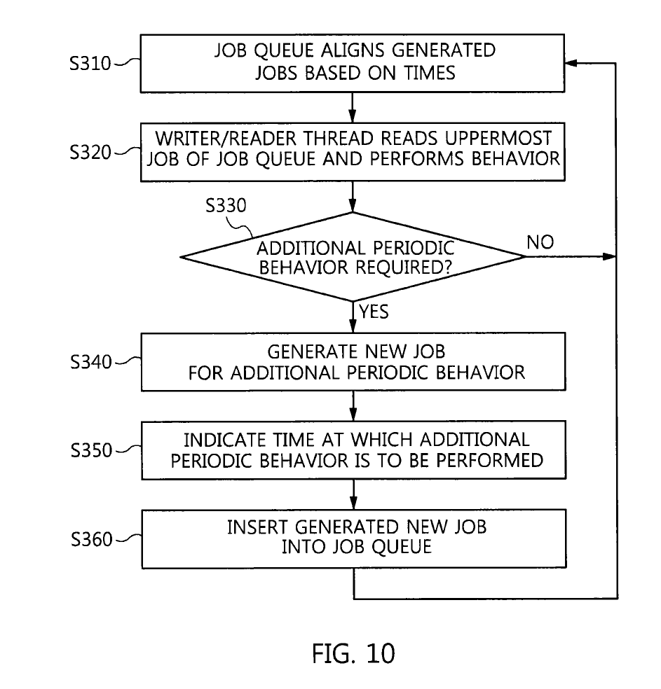

FIG. 10 is a flowchart showing in detail step S300, at which the writer thread or the reader thread performs a behavior in the RTPS layer, in the flowchart shown in FIG. 8.

Referring to FIG. 10, step S300 is configured such that a writer job queue or a reader job queue aligns jobs generated by the network thread based on times at step S310. In this case, each of the jobs generated by the network thread at step S310 may be composed of fields including an entity pointer, packet data, behavior status, and a job time schedule.

Next, the writer thread or the reader thread reads a job located at the uppermost position of the writer job queue or the reader job queue, and then performs a behavior in the RTPS layer at step S320.

If an additional periodic behavior to be performed by the writer thread or the reader thread is required at step S330, the network thread generates a new job required by the writer thread or the reader thread to perform the additional periodic behavior at step S340. In this case, the time at which the additional periodic behavior must be performed is indicated on the new job, generated by the network thread at step S340, at step S350.

The new job on which the time is indicated at step S350 is inserted into the writer job queue or the reader job queue at step S360, and step S310 is performed again.

The operations of the above-described apparatus for processing middleware for DDS and the method thereof according to the present invention may be implemented in the form of program instructions that can be executed by various types of computer means and may be recorded in a recording medium readable by a computer provided with a processor and memory. In this case, the computer-readable recording medium may include program instructions, data files, data structures, etc. independently or in combination. Meanwhile, the program instructions recorded in the recording medium may be designed or configured especially for the present invention, or may be well-known to and used by those skilled in the art of computer software.

Examples of the computer-readable recording medium may include magnetic media such as a hard disk, a floppy disk, and magnetic tape, optical media such as Compact Disk-Read Only Memory (CD-ROM) and a Digital Versatile Disk (DVD), magneto-optical media such as a floptical disk, and hardware devices especially configured to store and execute program instructions such as ROM, Random Access Memory (RAM), and flash memory. Meanwhile, such a recording medium may be a transfer medium such as light, a metal wire or a waveguide including carrier waves for transmitting signals required to designate program instructions, data structures, etc.

According to the present invention, there is an advantage in that the threads and memory resources are managed, thus improving the overall performance of DDS middleware without violating the data-centric characteristics of the DDS middleware.

Further, according to the present invention, there is an advantage in that a FIFO queue as was used in conventional DDS middleware has been replaced by a lock-free FIFO queue, so that the overall performance of DDS middleware can be improved in a situation in which write operations occur more frequently than do read operations.

Furthermore, there is an advantage in that writer/reader threads corresponding to writer/reader entities in DDS middleware are operated as a single writer/reader thread, so that system efficiency is improved, and in that jobs allocated to writer/reader threads are managed using a time-ordered writer/reader job queue so as to process periodic events or repetitive data, thus more efficiently performing the processing of repetitive data.

As described above, optimal embodiments of an apparatus and method for providing data in middleware for DDS according to the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible based on the embodiments. Therefore, the technical scope of the present invention should be defined by the technical spirit of the claims.

What is claimed is:

1. An apparatus for processing data in middleware for Data Distribution Service (DDS), comprising:
a network thread management module for managing, using a thread pool, a network thread which has sockets for transmitting or receiving data to or from a network in a Real-Time Publish/Subscribe (RTPS) layer that is a data transport layer of middleware for the DDS;
a lock-free queue management module for managing a lock-free queue which has a lock-free function and which transmits or receives the data to or from the network thread; and
a writer/reader thread management module for managing a writer thread and a reader thread so that the writer thread or the reader thread transmits or receives the data to or from the lock-free queue and performs a behavior in the RTPS layer.

2. The apparatus of claim 1, further comprising a memory management module that is allocated memory resources requested by the middleware from a system that uses the DDS and that provides the memory resources.

3. The apparatus of claim 2, wherein the memory management module comprises:
a memory management unit configured to be previously allocated predetermined memory resources from the system that uses the DDS and to manage the allocated memory resources;
a cache configured to, if the middleware requests memory resources of a specific data type, be allocated memory resources from the memory management unit, convert the allocated memory resources into a specific data type requested by the middleware, and provide the converted memory resources; and
a structure management unit configured to structure and manage data types requested by the middleware.

4. The apparatus of claim 3, wherein the structure management unit manages the data types requested by the middleware using one or more of tree, heap and buffer management structures.

5. The apparatus of claim 1, wherein the sockets are one or more of a Participant Discovery Protocol (PDP) socket, an Endpoint Discovery Protocol (EDP) socket, and a data socket.

6. The apparatus of claim 1, wherein the network thread comprises a socket manager for managing the sockets, and the socket manager is shared among network threads of the thread pool.

7. The apparatus of claim 6, wherein the socket manager uses a structure based on one or more of select, poll, epoll, and kqueue system call schemes.

8. The apparatus of claim 1, wherein the network thread generates a job to be allocated to the writer thread or the reader thread if new data arrives from the network.

9. The apparatus of claim 8, wherein the writer/reader thread management module comprises a job queue for allocating the job generated by the network thread to the writer thread or the reader thread.

10. The apparatus of claim 9, wherein the job comprises fields including an entity pointer, packet data, behavior status, and a job time schedule.

11. The apparatus of claim 1, wherein the lock-free queue is implemented using Compare And Swap (CAS) instructions.

12. A method of processing data in middleware for Data Distribution Service (DDS), comprising:
constructing a network thread which supports a thread pool and which has sockets for transmitting or receiving data to or from a network in a Real-Time Publish/Subscribe (RTPS) layer that is a data transport layer of middleware for the DDS;
the network thread transmitting data received from the network to a lock-free queue having a lock-free function; and
a writer thread or a reader thread reading the data from the lock-free queue and then performing a behavior in the RTPS layer.

13. The method of claim 12, wherein the constructing the network thread comprises:
integrating all network threads into a single network thread;
generating sockets based on the single network thread;
generating a socket manager for managing the sockets;
multiplexing the single network thread into a plurality of network threads, thus generating a thread pool;
connecting the socket manager to the sockets; and
connecting the socket manager to the thread pool so that the thread pool shares the socket manager.

14. The method of claim 12, wherein the sockets are one or more of a Participant Discovery Protocol (PDP) socket, an Endpoint Discovery Protocol (EDP) socket, and a data socket.

15. The method of claim 12, wherein the writer thread or the reader thread performing the behavior in the RTPS layer comprises:
a job queue aligning jobs generated by the network thread based on times; and
the writer thread or the reader thread reading a job located at an uppermost position of the job queue and then performing the behavior in the RTPS layer.

16. The method of claim 15, wherein the writer thread or the reader thread performing the behavior in the RTPS layer comprises:
if an additional periodic behavior to be performed by the writer thread or the reader thread is required, generating a new job for the additional periodic behavior; and
indicating a time at which the additional periodic behavior is to be performed, and inserting the generated new job into the job queue.

17. The method of claim 15, wherein the job comprises fields including an entity pointer, packet data, behavior status, and a job time schedule.

18. The method of claim 12, wherein the lock-free queue is implemented using Compare And Swap (CAS) instructions.
